(19) United States
(12) Patent Application Publication
(10) Pub. No.: US 2017/0018374 A1
(43) Pub. Date: Jan. 19, 2017

(54) Button Structure

(71) Applicant: COMPAL BROADBAND NETWORKS INC., Taipei City (TW)

(72) Inventors: Chiang-Chang Wu, Hsinchu County (TW); Cheng-Shan Lin, Hsinchu County (TW); Chung-Ming Pan, Hsinchu County (TW)

(21) Appl. No.: 15/012,865

(22) Filed: Feb. 2, 2016

Related U.S. Application Data
(60) Provisional application No. 62/193,099, filed on Jul. 16, 2015.

(30) Foreign Application Priority Data
Dec. 18, 2015 (TW) 104220390

(51) Int. Cl. H01H 3/12

(52) U.S. Cl. CPC H01H 3/12

(57) ABSTRACT

A button structure applied in an electronic device includes at least a flexible connector connected to a circuit board of the electronic device and a pressing portion located at a terminal of the at least a flexible connector. When a user presses the pressing portion, the pressing portion applies an acting force on the at least a flexible connector and the at least a flexible connector generates an electrical signal to the circuit board.

### CROSS REFERENCE TO RELATED APPLICATIONS

This application claims the benefit of U.S. provisional application No. 62/193,099, filed on Jul. 16, 2015 and incorporated herein by reference.

### BACKGROUND OF THE INVENTION

1. Field of the Invention

The present invention relates to a button structure, and more particularly, to a button structure applied for a circuit board vertically disposed within an electronic device.

2. Description of the Prior Art

For the comfort and convenience of usage, appearance of electronic devices tends to be with an all-in-one and simple style, so as to be suitable for various work or residential environments. In such a situation, how to provide a button structure for a vertically disposed circuit board disposed within an electronic device is a significant objective in the field.

### SUMMARY OF THE INVENTION

It is therefore a primary objective of the present invention to provide a button structure applied for a circuit board vertically disposed within an electronic device.

The present invention discloses a button structure applied in an electronic device. The button structure comprises at least a flexible connector, connected to a circuit board of the electronic device; and a pressing portion, located at a terminal of the at least a flexible connector; wherein when an external force is applied to the pressing portion, the pressing portion applies an action force on the at least a flexible connector, and the at least a flexible connector generates an electrical signal to the circuit board.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a portion of an electronic device according to an embodiment of the present invention.

FIG. 2 is a schematic explosive diagram of a button structure according to an embodiment of the present invention.

FIG. 3A is a schematic diagram of the button structure of FIG. 2 in a first perspective.

FIG. 3B is a schematic diagram of the button structure of FIG. 2 in a second perspective.

FIGS. 4A and 4B are schematic diagrams of a flexible connector connecting to a first plane and a second plane of a circuit board according to an embodiment of the present invention.

FIG. 5 is a schematic explosive diagram of a flexible connector.

### DETAILED DESCRIPTION

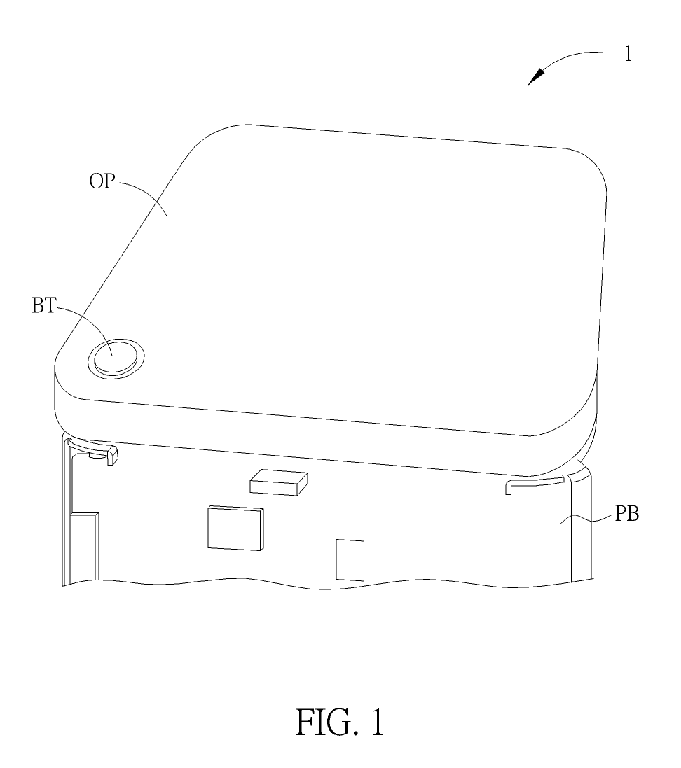

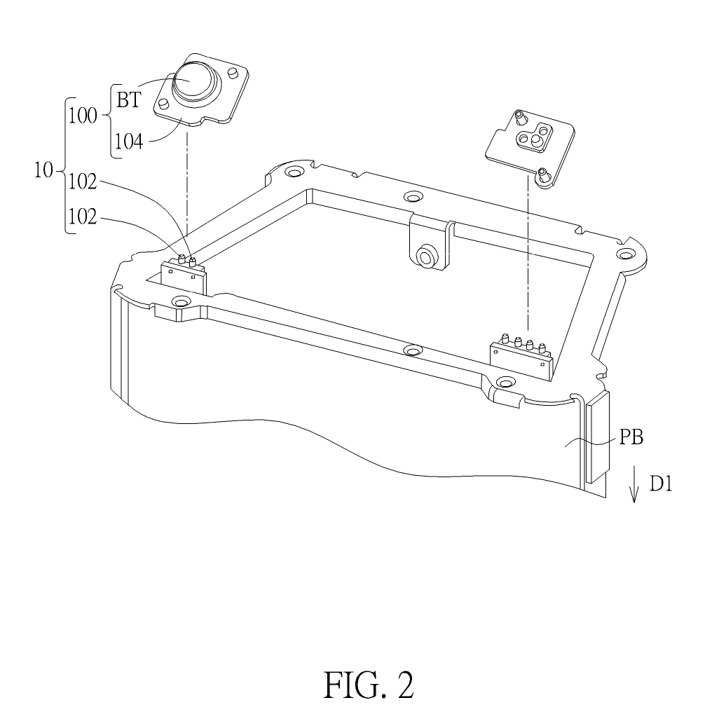

FIG. 1 is a schematic diagram of a portion of an electronic device 1 according to an embodiment of the present invention. As shown in FIG. 1, the electronic device 1 comprises a circuit board PB, a keycap BT and an operational plane OP. The circuit board PB is vertically disposed within the electronic device 1, which means that the circuit board PB is vertical to a base (not shown in FIG. 1) of the electronic device 1, and the keycap BT appears on the operational plane OP, such that a user may press the keycap BT and operate the electronic device 1 via the circuit board PB. FIG. 2 is a schematic explosive diagram of a button structure 10 according to an embodiment of the present invention. As shown in FIG. 2, the button structure 10 comprises a pressing portion 100 and a plurality of flexible connectors 102. The pressing portion 100 is located at a terminal of the flexible connectors 102, which comprises a button base 104 and the keycap BT. The pressing portion 100 may be covered by an up-cover (not illustrated in FIG. 2), such that only the keycap BT of the button structure 10 appears on a plane of the up-cover and the plane of the up-cover is the operational plane OP. The flexible connectors 102 are connected to the circuit board PB and extend toward the operational plane OP of the electronic device 1. The flexible connectors 102 are able to be shortened by external force. When the flexible connectors 102 are applied by external force and shortened, the flexible connectors 102 generate an electrical signal to the circuit board PB. In other words, when a user presses the keycap BT on the operational plane OP (i.e., an external force is applied to the pressing portion 100), the pressing portion 100 delivers an action force in a first direction D1 onto the flexible connectors 102, the flexible connectors 102 are shortened by the action force and generate the electrical signal to the circuit board PB, where the first direction D1 is a direction parallel to the flexible connectors 102. Therefore, the user may press the keycap BT and operate the electronic device 1 via the circuit board PB.

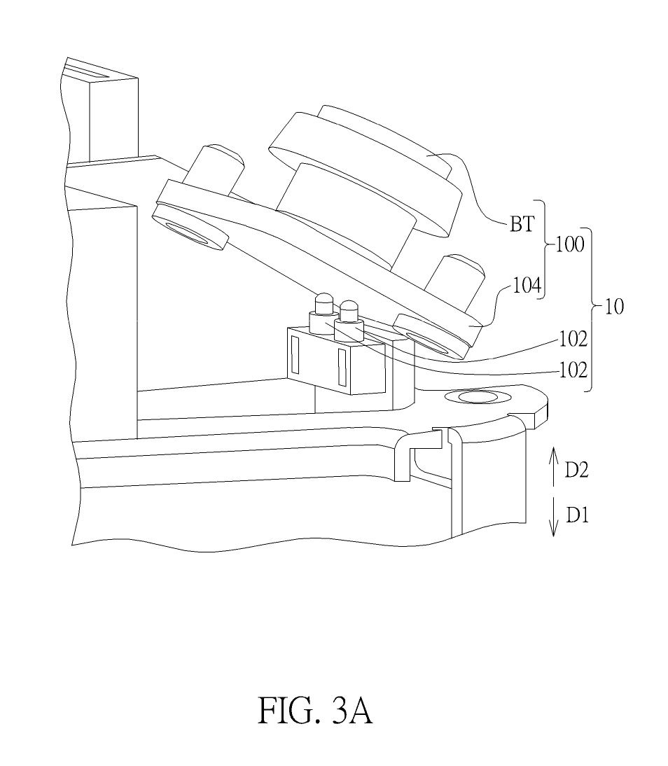

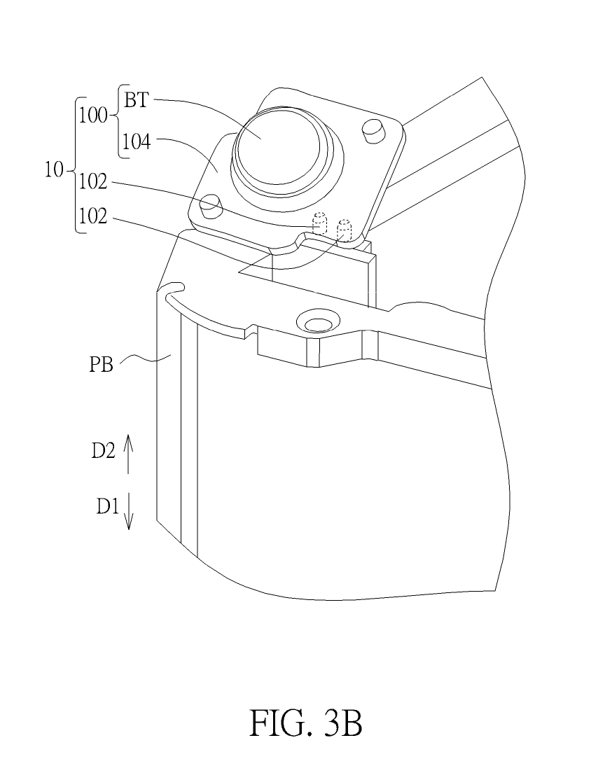

Furthermore, please refer to FIGS. 3A and 3B, which are schematic diagrams of the button structure 10 in a first perspective and a second perspective. As can be seen form FIGS. 3A and 3B, the pressing portion 100 are located on top of the flexible connectors 102. When the user presses the pressing portion 100, the flexible connectors 102 may be shorten by the action force and generate the electrical signal to the circuit board PB. On the other hand, when the user stops pressing and releases the pressing portion 100 (i.e., the action force is no longer applied on the pressing portion 100), the flexible connectors 102 may generate a reaction force in a second direction D2 onto the pressing portion 100, where the second direction D2 is an inverse direction of the first direction D1.

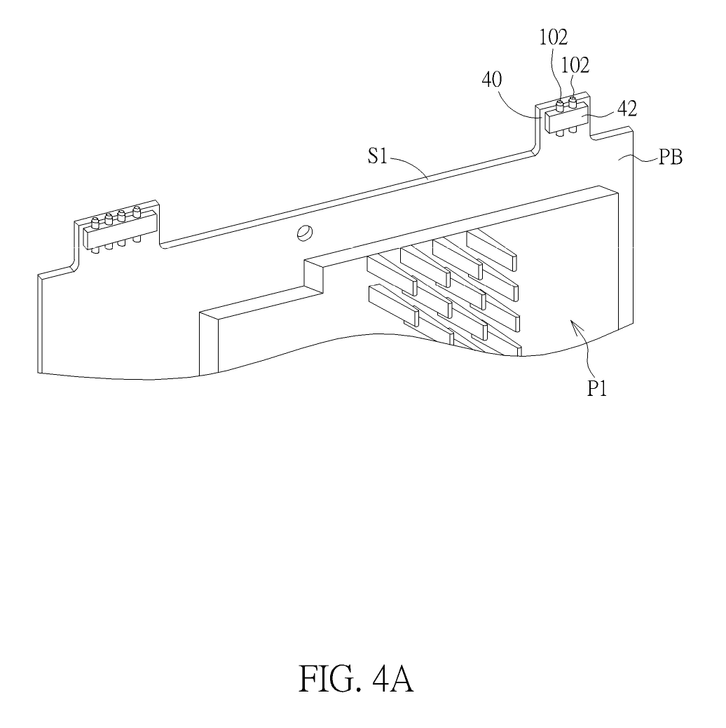

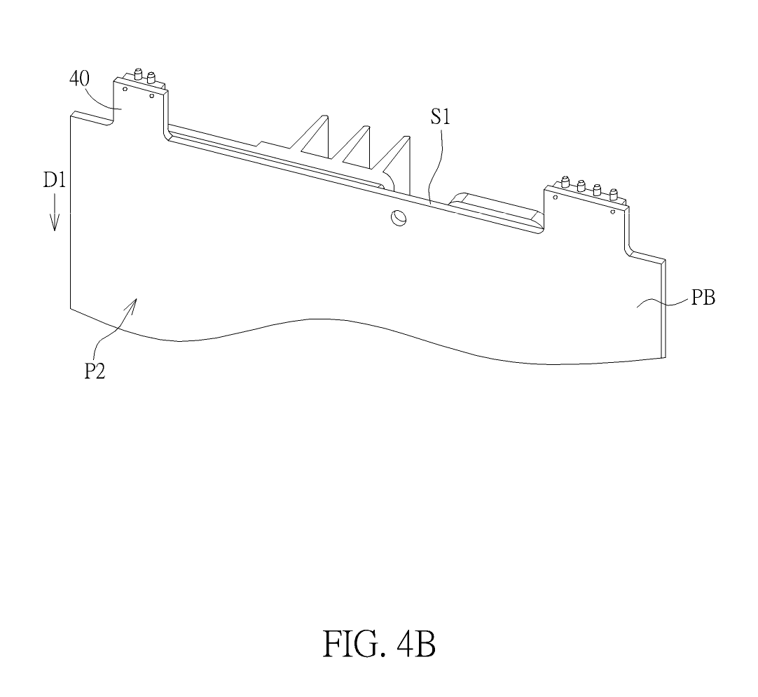

In addition, please refer to FIGS. 4A and 4B, which are schematic diagrams of the flexible connectors 102 connecting to a first plane P1 and a second plane P2 of the circuit board PB, respectively. The circuit board PB comprises a protrusion 40 and a fixing element 42. The protrusion 40 is connected to a side S1 of the circuit board PB and merged into the circuit board PB. The fixing element 42 is disposed on the first plane P1 of the protrusion 40, configured to fix the flexible connectors 102. That is, the flexible connectors 102 are disposed on the first plane P1 of the protrusion 40, such that the flexible connectors 102 is parallel to the circuit board PB and connected to the circuit board PB. Therefore, the electrical signal generated by the flexible connectors 102 may be delivered to the circuit board PB. In other words, the flexible connectors 102 are connected to the side S1 of the circuit board PB.

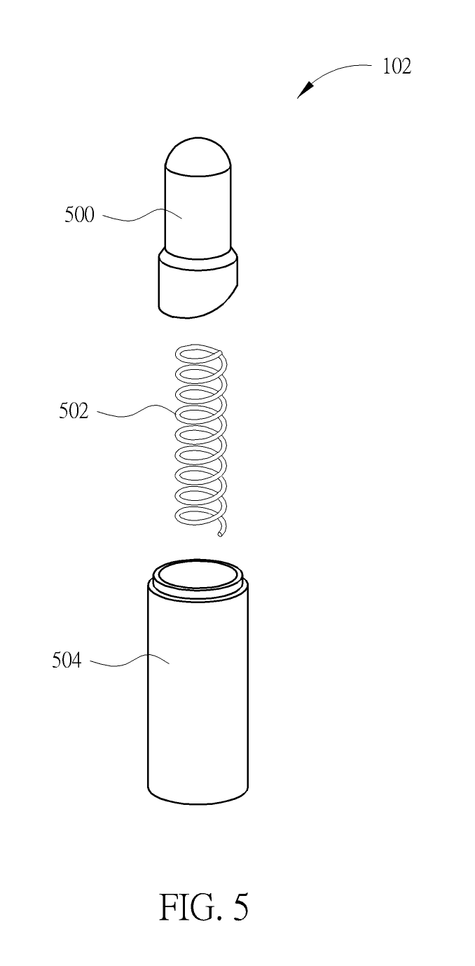

In addition, FIG. 5 is a schematic explosive diagram of the flexible connector 102. The flexible connector 102 may be a pogo pin, which comprises a plunger 500, a spring 502 and a barrel 504. The spring 502 is disposed on the barrel 504. The plunger 500 covers the spring 502 and the barrel 504, and is configured to bear the action force delivered from the pressing portion 100. When the user presses the pressing portion 100, the spring 502 inside the flexible connector 102 would be shortened by the action force, and the flexible connector 102 would generate an electrical current flowing from the plunger 500 through the barrel 504 to the circuit board PB. When the user stops pressing and releases the pressing portion 100, the spring 502 inside the flexible connector 102 would generate the reaction force onto the pressing portion 100.

As can be seen from the above, for the circuit board PB vertically disposed within the electronic device 1, the present invention connects the flexible connectors 102 to the side S1 of the circuit board PB. The user may apply the action force onto the flexible connectors 102 via the pressing portion 100, such that the flexible connectors 102 may be shortened by the force and generate the electrical signal to the circuit board PB. Hence, the user may operate the electronic device 1.

Notably, the embodiments stated in the above are utilized for illustrating the concept of the present invention. Those skilled in the art may make modifications and alternations accordingly, and not limited herein. For example, the circuit board PB is not limited to be vertically disposed within the electronic device 1. In practical application, the circuit board PB may be disposed within the electronic device in any angle. As long as when the user applies an action force onto the flexible connector while pressing the pressing portion, the flexible connector generates electrical signal to the circuit board, requirements of the present invention is satisfied. In addition, the button structure of the present invention may comprise only one flexible connector, instead of a plurality of flexible connectors, which is also within the scope of the present invention.

In summary, the present invention connects the flexible connectors to the circuit board. The user may apply the action force onto the flexible connectors via the pressing portion, such that the flexible connectors may be shortened by the force and generate the electrical signal to the circuit board. Hence, the user may operate the electronic device via the button structure of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A button structure, applied in an electronic device, comprising:
at least a flexible connector, connected to a circuit board of the electronic device; and
a pressing portion, located at a terminal of the at least a flexible connector;
wherein when an external force is applied to the pressing portion, the pressing portion applies an action force on the at least a flexible connector, and the at least a flexible connector generates an electrical signal to the circuit board.

2. The button structure of claim 1, wherein the at least a flexible connector is a pogo pin, and each flexible connector comprises:
a barrel;
a spring, disposed within the barrel; and
a plunger, covering the barrel and the spring, configured to bear the action force.

3. The button structure of claim 1, wherein the circuit board is vertically disposed within the electronic device.

4. The button structure of claim 1, wherein the at least a flexible connector is toward an operational plane of the electronic device.

5. The button structure of claim 1, wherein when the external force stops applying on the pressing portion, the at least a flexible connector generates a reaction force onto the pressing portion.

6. The button structure of claim 1, wherein the circuit board comprises a fixing element configured to fix the at least a flexible connector.

7. The button structure of claim 1, wherein the at least a flexible connector is connected to a side to the circuit board.

8. The button structure of claim 7, wherein the circuit board further comprises a protrusion protruding from the side of the circuit board, and the at least a flexible connector is disposed on a first plane of the protrusion.
